(19) United States
(12) Patent Application Publication
(10) Pub. No.: US 2013/0034327 A1
(43) Pub. Date: Feb. 7, 2013

(54) OPTICAL LINK MODULE

(71) Applicant: Takeshi BIWA, Fukuoka-ken (JP)

(72) Inventor: Takeshi BIWA, Fukuoka-ken (JP)

(73) Assignee: Kabushiki Kaisha Toshiba, Tokyo (JP)

(21) Appl. No.: 13/424,132

(22) Filed: Mar. 19, 2012

(30) Foreign Application Priority Data
Aug. 5, 2011 (JP) 2011-171896

(51) Int. Cl. G02B 6/36

(52) U.S. Cl. 385/77

(57) ABSTRACT

According to one embodiment, an optical link includes a case, an optical unit, a plate spring and a shutter. The case is provided with a plug-guided portion and a hole. The optical unit is operable to optically couple to the optical fiber. The plate spring has a hook at one end, the one end internally contacting with the hole and the hook being hooked to the case. The shutter is provided in the plug-guided portion. The shutter is rotating when the plug is inserted, and is turning into an opened state so as to couple the optical unit to the optical fiber while bending the plate spring. The shutter is turning into a closed state due to elastic bending stress of the plate spring when the plug is pulled out, and is blocking an optical path between the optical unit and the optical fiber.

### CROSS-REFERENCE TO RELATED APPLICATIONS

This application is based upon and claims the benefit of priority from the prior Japanese Patent Application No. 2011-171896 filed on Aug. 5, 2011; the entire contents of which are incorporated herein by reference.

### FIELD

Embodiments described herein relate generally to a optical link module.

### BACKGROUND

If video signals and audio signals are transmitted using optical signals instead of electrical signals, external noise to an electronic equipment and the influence on other electronic equipment by EMI (Electro-Magnetic Interference) can be reduced.

For example, connecting a digital amplifier to a TV receiver, a DVD (Digital Versatile Disc) player, a CD (Compact Disc) player, or the like with an optical fiber facilitates the transmission of high-quality signals.

In this case, it is required that an optical output terminal in a TV receiver or a DVD player does not directly emit optical signals toward human eyes for safety. In order to satisfy this requirement, it is preferable that the optical transmitter has a shutter. That is, when a plug is not inserted, the shutter can be closed, and hence the optical signal can be blocked. The use of a resin molded body for the case of an optical link module can reduce size and weight and can achieve high mass productivity. In this case, it is required that a shutter operates reliably even in the case where a plug provided on the optical fiber side is repeatedly put in and pulled out of a receptacle case or the like.

### BRIEF DESCRIPTION OF THE DRAWINGS

FIG. 1A is a schematic front view illustrating an optical link module according to a first embodiment, and FIG. 1B is a schematic cross-sectional view along a line A-A;

FIG. 2 is a schematic perspective view illustrating partially cutting the optical link module according to the first embodiment in a state in which the plug including the end of the optical fiber is fit into the optical link module;

FIG. 3A is a schematic plan view illustrating the plate spring, FIG. 3B a schematic cross-sectional view along a line B-B, and FIG. 3C is a side view;

FIG. 4A is a schematic cross-sectional view illustrating the portion around the hole 19, FIG. 4B is a schematic cross-sectional view along a line D-D crossing the hole before the plate spring is pressed into the hole, and FIG. 4C is a schematic cross-sectional view along the line D-D after the plate spring is pressed into the hole;

FIG. 5A is a photo diagram illustrating the lower surface of the hook, FIG. 5B is a photo diagram illustrating the inner wall after the plate spring is removed, and FIG. 5C is a graph illustrating the profile of the shape of the inner wall after the plate spring is removed;

FIG. 6A is a schematic front view illustrating an optical link module according to a comparative example, FIG. 6B is a schematic cross-sectional view illustrating a closed state along a line C-C, and FIG. 6C is a schematic cross-sectional view illustrating a state in which the position of a plate spring is displaced;

FIG. 7 is a graph illustrating the pulling-out strength of the plate spring;

FIG. 8 is a graph illustrating the dependency of a distance between the plate spring and the shutter on the number of times of the plug being put in and pulled out; and

FIG. 9 is a block diagram illustrating an exemplary application of the optical link module according to this embodiment.

### DETAILED DESCRIPTION

In general, according to one embodiment, an optical link is operable to be connected to a plug of an optical fiber. The module includes a case, an optical unit, a plate spring and a shutter. The case is provided with a plug-guided portion into which the plug is inserted, and a hole continuing to the plug-guided portion. The optical unit is provided in the case and operable to optically couple to the optical fiber. The plate spring has a hook at one end thereof, the one end internally contacting with the hole, the hook being hooked to the case. The shutter is provided in the plug-guided portion. The shutter is rotating in the plug-guided portion when the plug is inserted into the plug-guided portion, and is turning into an opened state so as to couple the optical unit to the optical fiber while bending the plate spring. The shutter is turning into a closed state due to elastic bending stress of the plate spring when the plug is pulled out of the plug-guided portion, and is blocking an optical path between the optical unit and the optical fiber.

Hereinafter, an embodiment of the invention will be described with reference to the drawings.

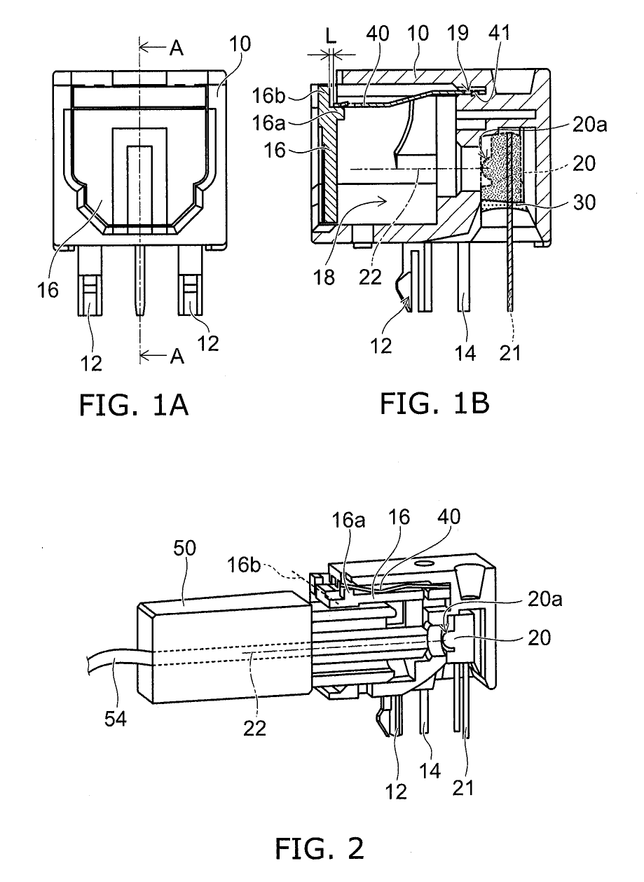

FIG. 1A is a schematic front view illustrating an optical link module according to a first embodiment, and FIG. 1B is a schematic cross-sectional view along a line A-A.

The first embodiment is an optical link module having a receptacle structure in which a plug including the end of an optical fiber can be inserted. The optical link module has a case 10, an optical unit 20, a plate spring 40, and a shutter 16.

The case 10 formed of a resin molded body or the like is provided with a plug-guided portion 18, into which the plug is inserted, and a hole 19 continuing to the plug-guided portion 18. The optical unit 20 is provided in the recess of the case 10, and fixed with a resin adhesive 30, for example. A lead terminal 21 of the optical unit 20 is lead out to the outside of the case 10. The case 10 has a guide pin 12. The provision of a reinforcing terminal 14 made of phosphor bronze or the like can facilitate mounting, and can improve mounting strength to a mounting substrate or the like.

For a molded body material, for example, a PBT (Polybutylene Terephthalate) resin, a PC (Polycarbonate) resin, or the like can be used. A PBT resin and a PC resin are a thermoplastic resin, and become soft when heated at a glass transition point or more for easy shaping. It is noted that a conductive resin is used to enhance the shield effect of the case.

Suppose that the optical unit 20 includes a light emitting element or the like and is covered with a transparent resin molded body or the like. In the case where the light emitting element is a surface emitting type element, an optical axis 22 can be defined as an axis that passes through the center of emission light and is vertical to the surface of the light emitting device.

Suppose that the optical unit 20 has a light receiving element, the optical axis 22 can be defined as an axis that passes through the center of receiving light and is vertical to the light receiving surface of the light receiving element. In any case, when the optical axis 22 is in alignment with the center line of an optical fiber, optical coupling efficiency can be increased.

The optical unit 20 may have a driver that can operate the light emitting element according to an input signal. Suppose that a transparent resin molded body above the light emitting element is a convex lens 20a, emitted light from the light emitting element can be collected and incident efficiency to the optical fiber can be increased. The optical unit may have a light receiving IC having a light receiving element and an amplifier integrated with each other.

After the optical unit 20 is inserted into the recess of the case 10, the resin adhesive 30 including epoxy or the like is applied to the optical unit 20 for thermosetting, and then the axial displacement between the optical axis 22 and the optical fiber is suppressed.

The plate spring 40 has a hook 41 at one end thereof. The one end of the plate spring 40 is pressed into the hole 19 of the case 10, and internally contacts with the inner wall. With this operation, the hook 41 is hooked to the case 10 so as to engage with the case 10, and it is suppressed that the hook 41 protrudes outwardly from the hole 19.

The shutter 16 is provided in the plug-guided portion 18. When the plug is inserted into the plug-guided portion 18, the shutter 16 is rotated about a mounting shaft 16b and opened while bending the plate spring 40. Namely, the optical unit 20 and the optical fiber can be optically coupled to each other.

It is noted that the shutter 16 can be made of such a material as a POM (Polyoxymethylene) resin.

When the plug is pulled out, the shutter 16 is closed due to the elastic bending stress of the plate spring 40. Namely, an optical path between the optical unit 20 and the optical fiber is blocked. It is noted that FIG. 1B shows the state of the shutter closed. In this case, the plate spring 40 pushes the side face of a projection 16a of the shutter 16, and keeps the plate-shaped shutter almost vertically.

FIG. 2 is a schematic perspective view illustrating partially cutting the optical link module according to the first embodiment in a state in which the plug including the end of the optical fiber is fit into the optical link module.

Namely, FIG. 2 is a diagram illustrating the optical link module cut in a plane including a plane A-A shown in FIG. 1. Suppose that the optical unit 20 has a light emitting element. A plug 50 has one end of an optical fiber 54 therein. In this case, preferably, the center axis of the optical fiber 54 is almost in alignment with the optical axis 22 of the optical unit 20.

In the state in which the plug 50 is fit into the plug-guided portion 18, the plate-shaped shutter 16 is rotated by the plug 50, and is almost horizontal. In this case, the plate spring 40 is bent. It is noted that the shutter 16 may have the projection 16a toward the inner side of the plug-guided portion 18. In the open state in FIG. 2, one other end of the plate spring 40 contacts with the top surface of the projection 16a.

Suppose that the plug 50 and the plug-guided portion 18 are made of a resin, the plug 50 and the plug-guided portion 18 have a snap-fit structure or the like for facilitating fitting the plug 50 into the plug-guided portion 18. Suppose that the shutter 16 is made of a resin, the shutter 16 is readily fit into the case 10. The shutter 16 may be a metal.

APF (All Plastic Fiber) having a core diameter of 980 μm and a cladding diameter of 1,000 μm, for example, is used for the optical fiber 54. APF has a minimum value in a red wavelength range of 650 nm to 670 nm, a minimum value of 400 dB/km or less in transmission loss, for example. Thus, it is readily make a transmission distance 50 m, for example. It is noted that the use of PCF (Plastic Cladding Silica Fiber) for the optical fiber can make the transmission distance 1,000 m.

In the case where the plug 50 is pulled out, the bent plate spring 40 rotates the shutter 16 about the shaft 16b due to elastic bending stress, and closes the shutter 16 (FIG. 1B). In this case, the shutter 16 is smoothly opened and closed because the plate spring 40 is reliably held in the hole 19.

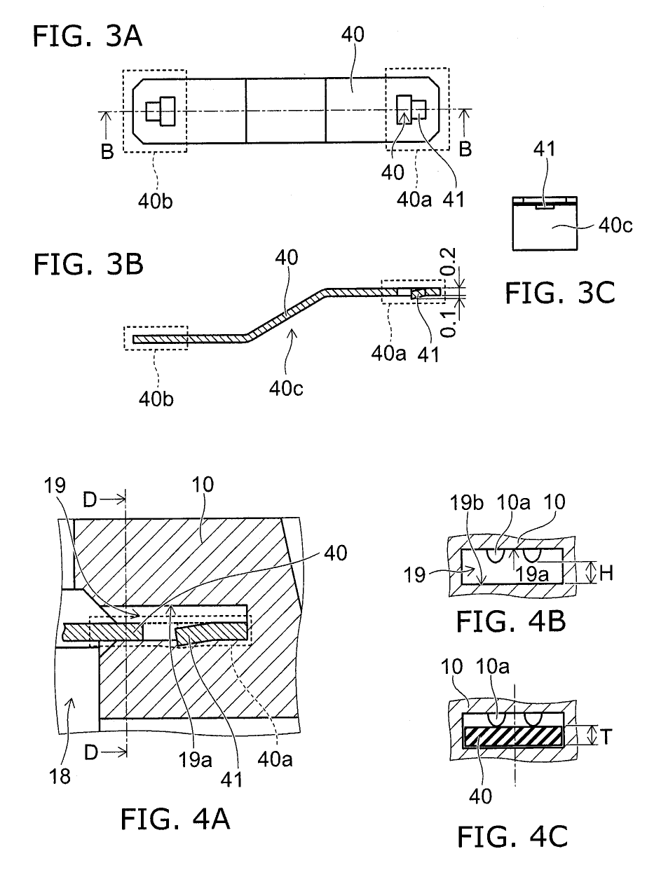

FIG. 3A is a schematic plan view illustrating the plate spring, FIG. 3B a schematic cross-sectional view along a line B-B, and FIG. 3C is a schematic side view.

The one end 40a of the plate spring 40 is pressed into the hole 19 of the case 10. The plate spring 40 is made of SUS 302 stainless steel or the like, for example, having a thickness of 0.2 mm, and the hook 41 is bent 0.1 mm, for example, downwardly below the lower surface of the plate spring 40. The other end 40b of the plate spring 40 contacts with the projection 16a of the shutter 16, for example. It is noted that when a bent portion 40c is provided at the middle portion of the plate spring 40 as illustrated in FIG. 3B, elastic bending stress can be more effectively transmitted to the shutter 16.

FIG. 4A is a schematic cross-sectional view illustrating the portion around the hole 19, FIG. 4B is a schematic cross-sectional view along a line D-D crossing the hole before the plate spring is pressed into the hole, and FIG. 4C is a schematic cross-sectional view along the line D-D after the plate spring is pressed into the hole.

As illustrated in FIG. 4B, the hole 19 has inner walls 19a and 19b extending in a direction in which the plug is inserted and faced to each other. A protrusion 10a such as a boss is provided on the one inner wall 19a of the hole 19. A height H between the other inner wall 19b and the protrusion 10a is 0.16 mm, for example. The projection 10a is deformed even though the thickness of the plate spring 40 is 0.2 mm, so that it is possible to press the plate spring 40 into the hole 19 and cause the plate spring 40 internally contact with the inner walls 19a and 19b. On the other hand, the hook 41 is hooked so as to engage with the inner wall 19b, so that it is possible to reliably fix the plate spring 40 into the hole 19.

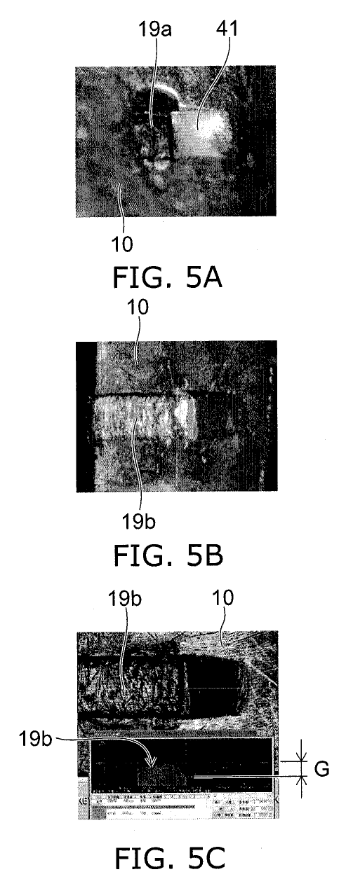

FIG. 5A is a photo diagram illustrating the lower surface of the hook, FIG. 5B is a photo diagram illustrating the inner wall after the plate spring is removed, and FIG. 5C is a graph illustrating the profile of the shape of the inner wall after the plate spring is removed.

It is noted that the case 10 was made of a PBT resin and the plate spring 40 was made of SUS 302 stainless steel. As illustrated in FIG. 5B and FIG. 5C, the hook 41 of the plate spring 40 is hooked to the inner wall 19b in a depth G of about 0.1 mm, and suppresses the plate spring 40 to protrude outwardly.

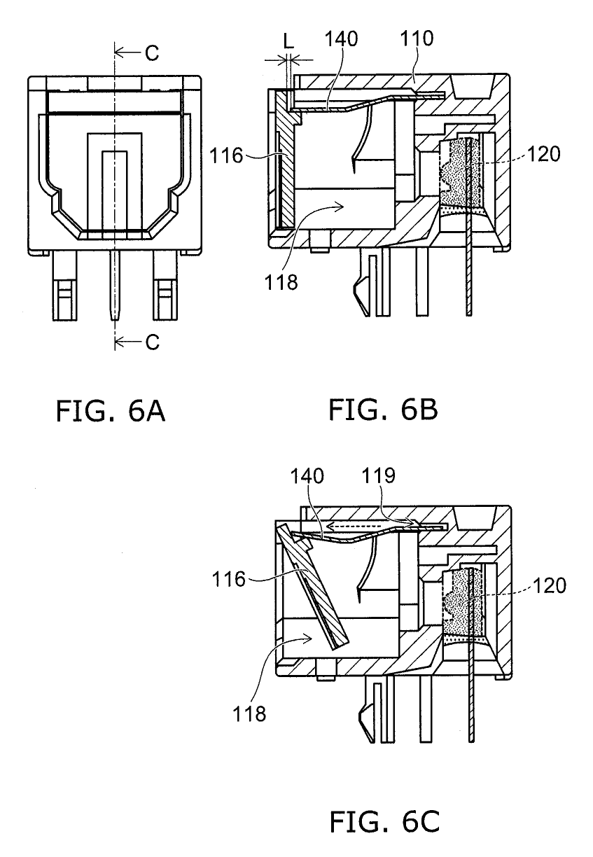

FIG. 6A is a schematic front view illustrating an optical link module according to a comparative example, FIG. 6B is a schematic cross-sectional view illustrating a closed state along a line C-C, and FIG. 6C is a schematic cross-sectional view illustrating a state in which the position of a plate spring is displaced.

In the comparative example, a hook is not provided on a plate spring 140, and one end of the plate spring 140 is just pressed into a hole 119. Thus, when a plug is repeatedly put in and pulled out, an outward stress is more strongly applied to the plate spring 140. Thus, the plate spring 140 tends to protrude outwardly. In the state in which the plate spring is outwardly displaced, the plate spring cannot rotate to return at the original position if the tip of the plate spring contacts with a shutter 116, and the plate spring cannot sufficiently press the shutter 116 downwardly. As a result, as illustrated in FIG. 6C, the shutter 116 is half opened as the tip of the shutter 116 is retracted on the inner side.

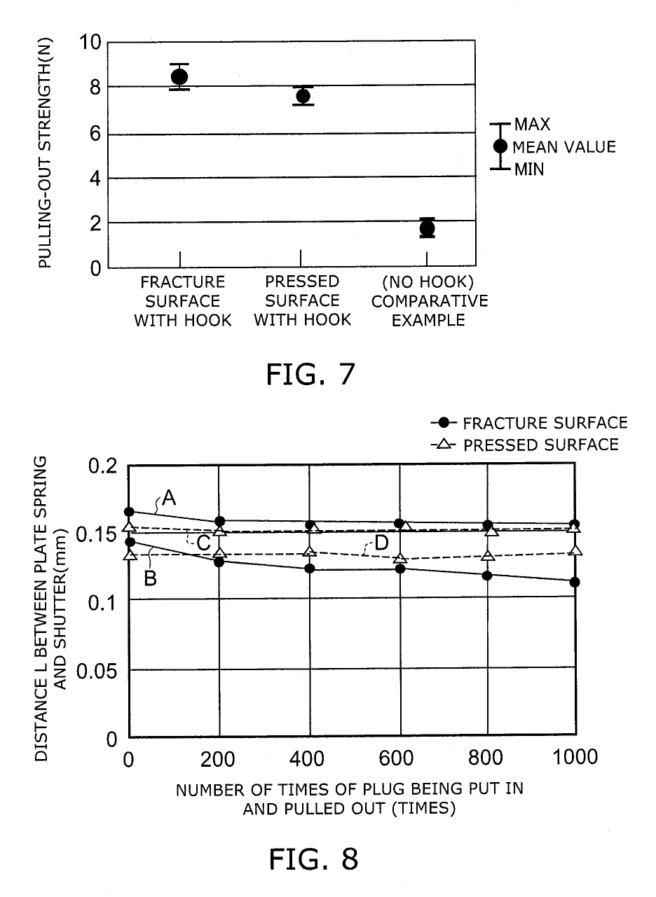

FIG. 7 is a graph illustrating the pulling-out strength of the plate spring.

It is noted that the case 10 is made of a PBT resin in any cases and the plate spring 40 is made of SUS 302 stainless steel. In the case of the comparative example illustrated in FIG. 6A to FIG. 6C, the pulling-out strength of the plate spring was distributed between 1.2 N (Newton) to 1.9 N, and the mean value was 1.5 N.

On the other hand, in this embodiment, in the case where the hook surface is a fracture surface, the pulling-out strength was distributed between 7.7 N to 9.0 N, and the mean value was improved for 8.3 N. In the case where the hook surface is a pressed surface, the pulling-out strength was distributed between 7.0 N to 7.9 N, and the mean value was 7.4 N. In the case of the pressed surface, although the pulling-out strength is reduced by about 11% more than the case of the fracture surface, the pulling-out strength is about 4.9 times the pulling-out strength of the comparative example for greater improvement.

FIG. 8 is a graph illustrating the dependency of a distance between the plate spring and the shutter on the number of times of the plug being put in and pulled out.

The vertical axis expresses a distance L (mm) between the plate spring and the shutter, and the horizontal axis expresses the number of times of the plug being put in and pulled out (times). A solid black circle expresses the case of the fracture surface, and a solid white triangle expresses the case of the pressed surface. In the case where the hook has a fracture surface, the distance L was shortened in a sample A by 0.015 mm (8.8%) and in a sample B by 0.027 mm (18%), between the initial state and the 1,000th time of the plug being put in and pulled out.

In the case where the hook has a pressed surface, the distance L was shortened in a sample C by 0.001 mm (0.7%) and in a sample D by 0.006 mm (2.9%). Regardless of the hook having a fracture surface or a pressed surface, since a change in the distance L can be made smaller, the shutter can be rotated to return at the original position. Thus, the operation of the shutter was able to be kept normally even after 1,000 times of the plug being put in and pulled out. On the contrary, as shown in FIG. 6C of the comparative example, the shutter was unable to operate 100% when the number of times of the plug being put in and pulled out was 100 times or less.

A PC resin can also be used for the material of the case 10. The glass transition point of a PC resin is a temperature of 120° C. or more, higher than temperatures of 30 to 40° C. for the transition point of a PBT resin. Thus, the stress relaxation of the resin is small even though the optical unit 20 is heated and cured in the case 10 using the adhesive 30 at temperatures of 70 to 100° C., so that it is possible to reduce fluctuations in the distance L between the plate spring 40 and the shutter 16 more than in the structure using a PBT resin. However, a PC resin has a low flame resistance, and has limitations on environments for use. In the process steps of mounting the optical link module on the mounting substrate, the case is sometimes molten in solder. A PC resin is expensive, so that it cannot be said that a PC resin is enough for mass production. Namely, a PBT resin is more preferable in appellations in which flame resistance, resistance of melting in solder, mass productivity, or the like is demanded.

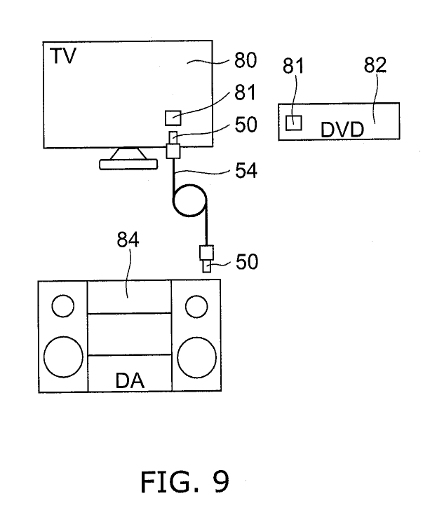

FIG. 9 is a block diagram illustrating an exemplary application of the optical link module according to this embodiment.

In the case where the optical link module includes an optical transmitter, the optical link module functions as an optical output terminal 81 for digital audio signals of a TV receiver 80, a DVD player 82, a CD player, a BS tuner, or the like. For example, in the case of the TV receiver 80, the optical link module is often provided on the back surface side opposite to a liquid crystal screen side.

The plug 50 is included in the optical fiber 54. An optical digital audio signal is inputted to an input terminal for optical digital sounds of audio equipment 84 such as a digital amplifier. For the input terminal for optical digital sounds, an optical receiver can be used. In this case, it is sufficient that the optical unit 20 has a light receiving element in the optical link module according to this embodiment.

In the optical receiver, a protection cap is often inserted in order to protect the front surface of the light receiving element against dust and foreign substances in a state in which the plug 50 is not inserted. The shutter 16 according to this embodiment also has the function of a protection cap. Thus, it is possible to transmit high-quality audio signals to audio equipment while reducing electromagnetic noise.

In the case of a CD player in compliance with the digital audio interface (DAI) standard, the sampling frequency is 44.1 kHz, for example. Thus, it is sufficient that the transmission rate is 2.82 MHz or more, and APF or PCF can be used for the optical fiber 54.

Furthermore, it is possible to also transmit high-quality optical digital video signals using the optical link module according to this embodiment. It is noted that audio signals and video signals may be analog signals.

In accordance with the optical link module according to this embodiment, it is possible to reliably operate the shutter even though the plug having an optical fiber is repeatedly put in and pulled out. Thus, it is possible to reduce the influence of electromagnetic noise, and it is possible to implement a highly reliable optical link system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An optical link module operable to be connected to a plug of an optical fiber, the module comprising:
a case provided with a plug-guided portion into which the plug is inserted and a hole continuing to the plug-guided portion;
an optical unit provided in the case and operable to optically couple to the optical fiber;
a plate spring having a hook at one end thereof, the one end internally contacting with the hole, the hook being hooked to the case; and
a shutter provided in the plug-guided portion, the shutter rotating in the plug-guided portion when the plug is inserted into the plug-guided portion and turning into an opened state so as to couple the optical unit to the optical fiber while bending the plate spring, the shutter turning into a closed state due to elastic bending stress of the plate spring when the plug is pulled out of the plug-guided portion and blocking an optical path between the optical unit and the optical fiber.

2. The module according to claim 1, wherein:
the hole has a first inner wall and a second inner wall extending in a direction in which the plug is inserted and faced to each other;
the first inner wall has a protrusion; and
the plate spring internally contacts with the second inner wall and the protrusion, and the hook is hooked to the second inner wall.

3. The module according to claim 1, wherein:
the shutter has a projection projecting toward internally; and
one other end of the plate spring contacts with the projection.

4. The module according to claim 3,
wherein the plate spring has a bent portion in a middle portion.

5. The module according to claim 3,
wherein in the open state, the one other end of the plate spring contacts with a top surface of the projection.

6. The module according to claim 3,
wherein in the open state, the one other end of the plate spring pushes a side face of the projection.

7. The module according to claim 1,
wherein the case is made of a resin.

8. The module according to claim 7,
wherein the resin is polybutylene terephthalate.

9. An optical link module operable to be connected to a plug having an optical fiber, the module comprising:
a case provided with a plug-guided portion into which the plug is inserted and a hole continuing to the plug-guided portion;
an optical unit provided in the case and having a light emitting element;
a plate spring having a hook at one end thereof, the one end internally contacting with the hole, the hook being hooked to the case; and
a shutter provided in the plug-guided portion, the shutter rotating in the plug-guided portion when the plug is inserted into the plug-guided portion and turning into an opened state so as to introduce light emitted from the light emitting element to the optical fiber while bending the plate spring, the shutter turning into a closed state due to elastic bending stress of the plate spring when the plug is pulled out of the plug-guided portion and blocking an optical path between the light emitting device and the optical fiber.

10. The module according to claim 9, wherein:
the hole has a first inner wall and a second inner wall extending in a direction in which the plug is inserted and faced to each other;
the first inner wall has a protrusion; and
the plate spring internally contacts with the second inner wall and the protrusion, and the hook is hooked to the second inner wall.

11. The module according to claim 9, wherein:
the shutter has a projection projecting toward internally; and
one other end of the plate spring contacts with the projection.

12. The module according to claim 9,
wherein the case is made of a resin.

13. The module according to claim 9,
wherein the optical unit further has a transparent resin molded body covering the light emitting device.

14. The module according to claim 13,
wherein the transparent resin molded body has a convex lens having an optical axis including an optical axis of the light emitting device.

15. An optical link module operable to be connected to a plug having an optical fiber, the module comprising:
a case provided with a plug-guided portion into which the plug is inserted and a hole continuing to the plug-guided portion;
an optical unit provided in the case and having a light receiving element;
a plate spring having a hook at one end thereof, the one end internally contacting with the hole, the hook being hooked to the case; and
a shutter provided in the plug-guided portion, the shutter rotating in the plug-guided portion when the plug is inserted into the plug-guided portion and turning into an opened state so as to introduce light emitted from the optical fiber to the light receiving element while bending the plate spring, the shutter turning into a closed state due to elastic bending stress of the plate spring when the plug is pulled out of the plug-guided portion and blocking an optical path between the light receiving element and the optical fiber.

16. The module according to claim 15, wherein:
the hole has a first inner wall and a second inner wall extending in a direction in which the plug is inserted and faced to each other;
the first inner wall has a protrusion; and
the plate spring internally contacts with the second inner wall and the protrusion, and the hook is hooked to the second inner wall.

17. The module according to claim 15, wherein:
the shutter has a projection projecting toward internally; and
one other end of the plate spring contacts with the projection.

18. The module according to claim 15,
wherein the case is made of a resin.

19. The module according to claim 15,
wherein the optical unit further has a transparent resin molded body covering the light emitting device.
